(19) United States
(12) Patent Application Publication
(10) Pub. No.: US 2026/0351225 A1
(43) Pub. Date: Nov. 5, 2026

(54) SYNTHESIS DEVICE OF SINGING VOICE AND METHOD OF USING THE SAME

(71) Applicants: HYUNDAI MOTOR COMPANY, Seocho-gu (KR); Kia Corporation, Seocho-gu (KR)

(72) Inventor: Hee Jo YOU, Gyeonggido (KR)

(21) Appl. No.: 19/416,610

(22) Filed: Dec. 11, 2025

(30) Foreign Application Priority Data
Apr. 30, 2025 (KR) 10-2025-0057592

(51) Int. Cl. G10H 1/00; G10L 13/033; G10L 15/06; G10L 17/18; G10L 25/03

(52) U.S. Cl. CPC G10H 1/00; G10L 13/0335; G10L 15/063; G10L 17/18; G10L 25/03; G10H 2250/311; G10H 2250/455

(57) ABSTRACT

A device and method for synthesizing a singing voice. The synthesis device includes a processor that synthesizes the singing voice based on raw voice data of a speaker. The processor includes a preprocessor that extracts voice feature data based on the raw voice data, and extracts musical instrument digital interface (MIDI) feature data of input MIDI data, a modulator that extracts modulation voice data based on the voice feature data, and a synthesizer that synthesizes the singing voice based on the voice feature data and the MIDI feature data.

### CROSS-REFERENCE TO RELATED APPLICATION

Pursuant to 35 U.S.C. § 119(a), this application claims the benefit of an earlier filing date and right of priority to Korean Patent Application No. 10-2025-0057592, filed in the Korean Intellectual Property Office on Apr. 30, 2025, the entire contents of which are incorporated herein by reference.

### TECHNICAL FIELD

The present disclosure relates to synthesizing a singing voice.

### BACKGROUND

Singing voice synthesis (SVS) is a technique for synthesizing singing data so as to include pitch and emotion. An SVS system can naturally synthesize songs by using text, a singing voice, and musical instrument digital interface (MIDI) data including melodic information as inputs. As the range of application scenarios of AI-based intelligent devices increases, deep learning models are applied to SVS models.

### SUMMARY

According to an aspect of the present disclosure, a synthesis device includes a processor that synthesizes a singing voice based on raw voice data of a speaker. The processor includes a preprocessor that extracts voice feature data based on the raw voice data, and extracts musical instrument digital interface (MIDI) feature data of input MIDI data, a modulator that extracts modulation voice data based on the voice feature data, and a synthesizer that synthesizes the singing voice based on the voice feature data and the MIDI feature data.

In an implementation, the voice feature data may include pitch data and spectrogram data extracted based on a predetermined hyperparameter, and the MIDI feature data may include height feature data from converting sound pitch, length feature data from converting a sound length, and phoneme feature data from converting text.

In an implementation, the modulator may include a modulation encoder that encodes the spectrogram data into first vector data including time data, a modulation decoder that decodes the first vector data and the pitch data into modulation voice data, and a speaker classifier that predicts the arbitrary speaker based on the first vector data.

In an implementation, each of the modulation encoder and the modulation decoder may include a convolution layer.

In an implementation, the modulation decoder may perform learning so as to reduce an error between first spectrogram data extracted from the raw voice data and second spectrogram data generated from the modulation voice data by using a first loss function.

In an implementation, the first loss function may include a mean absolute error (MAE).

In an implementation, the speaker classifier may include a gradient reversal layer (GRL) that removes speaker data from the first vector data.

In an implementation, the synthesizer may include a MIDI encoder that encodes the MIDI feature data into second vector data by using an embedding layer and calculates a probability distribution of the second vector data by learning the second vector data through a learning model, a modulation encoder that encodes the spectrogram data into the first vector data including time data, and calculates a probability distribution of the encoded first vector data by using a convolution layer, a normalization module that transforms the second vector data by using a normalizing flow and matches the probability distribution of the second vector data with the probability distribution of the first vector data, a decoder that generates Mel-spectrogram based on the probability distribution of the first vector data and the probability distribution of the second vector data, and a vocoder that synthesizes the singing voice based on the Mel-spectrogram.

In an implementation, the normalization module may perform learning to match the probability distribution of the first vector data with the probability distribution of the second vector data by using a second loss function.

In an implementation, the learning model may include a transformer, and the second loss function may include Kullback-Leibler (KL) divergence.

According to an aspect of the present disclosure, a synthesis method in which a synthesis device synthesizes a singing voice based on raw voice data of a speaker includes extracting voice feature data based on the raw voice data thus input, and extracting MIDI feature data of input MIDI data, extracting modulation voice data based on the voice feature data, and synthesizing the singing voice based on the voice feature data and the MIDI feature data.

In another implementation, the voice feature data may include pitch data and spectrogram data extracted based on a predetermined hyperparameter, and the MIDI feature data may include height feature data from converting sound pitch, length feature data from converting a sound length, and phoneme feature data from converting text.

In another implementation, the extracting of the voice feature data may include encoding, by a modulation encoder, the spectrogram data into first vector data including time data, decoding, by a modulation decoder, the first vector data and the pitch data into modulation voice data, and predicting, by a speaker classifier, the arbitrary speaker based on the first vector data.

In another implementation, each of the modulation encoder and the modulation decoder may include a convolution layer.

In another implementation, the modulation decoder may perform learning so as to reduce an error between first spectrogram data extracted from the raw voice data and second spectrogram data generated from from the modulation voice data by using a first loss function.

In another implementation, the first loss function may include a MAE.

In another implementation, the speaker classifier may include a GRL that removes speaker data from the first vector data.

In another implementation, the synthesizing of the singing voice may include encoding, by a MIDI encoder, the MIDI feature data into second vector data by using an embedding layer and calculating a probability distribution of the second vector data by learning the second vector data through a learning model, encoding, by a modulation encoder, the spectrogram data into the first vector data including time data, and calculating a probability distribution of the encoded first vector data by using a convolution layer, transforming, by a normalization module, the second vector data by using a normalizing flow and matching the probability distribution of the second vector data with the probability distribution of the first vector data, generating, by a decoder, Mel-spectrogram based on the probability distribution of the first vector data and the probability distribution of the second vector data, and synthesizing, by a vocoder, the singing voice based on the Mel-spectrogram.

In another implementation, the normalization module may perform learning to match the probability distribution of the first vector data with the probability distribution of the second vector data by using a second loss function.

In another implementation, the learning model may include a transformer, and the second loss function may include KL divergence.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing an example configuration of a synthesis device of a singing voice, according to an implementation of the present disclosure;

FIG. 2 is a block diagram showing an example configuration of a processor, according to an implementation of the present disclosure;

FIG. 3 is a drawing illustrating an example of an operation of a synthesizer, according to an implementation of the present disclosure;

FIG. 4 is a flowchart illustrating an example of a synthesis method of a synthesis device of a singing voice, according to an implementation of the present disclosure;

FIG. 5 is a flowchart for describing an example of an operation of a preprocessor, according to an implementation of the present disclosure;

FIG. 6 is a flowchart for describing an example of an operation of a modulator, according to an implementation of the present disclosure;

FIG. 7 is a flowchart for describing an example of an training of a modulator, according to an implementation of the present disclosure;

FIG. 8 is a flowchart for describing an example of an operation of a synthesizer, according to an implementation of the present disclosure; and

FIG. 9 is a block diagram illustrating an example of a computing system, according to an implementation of the present disclosure.

### DETAILED DESCRIPTION

Implementations of the present disclosure can provide a device for synthesizing voice data into a singing voice by using a learning model, and a method thereof.

Singing voice synthesis (SVS) technology typically focuses on synthesizing singing voices. For example, in some SVS technology scenarios, a specific singer's singing voice and a specific language are used as input data and then the input data is applied to a deep learning model. However, these types of SVS technology are still inadequate in synthesizing new audible voices based on arbitrary singing voices and arbitrary languages spoken by a wide range of users, including users other than singers. For example, a user may not be a singer, and thus it can be difficult for such users to sing along with a music score. Furthermore, a process of transcribing a music score when an arbitrary singing voice is converted into a new singing voice can have disadvantages of requiring specialized skills.

Implementations of the present disclosure can provide a technology for synthesizing an arbitrary voice, in which there is no prior singing data, into a singing voice by using a learning model.

Implementations of the present disclosure can provide a device for synthesizing arbitrary voice data into a singing voice by using a learning model, and a method thereof.

The technical problems to be solved by the present disclosure are not limited to the aforementioned problems, and any other technical problems not mentioned herein will be clearly understood from the following description by those skilled in the art to which the present disclosure pertains.

Hereinafter, some implementations of the present disclosure will be described in detail with reference to the accompanying drawings. In adding reference numerals to components of each drawing, it should be noted that the same components include the same reference numerals, although they are indicated on another drawing. Furthermore, in describing the implementations of the present disclosure, detailed descriptions associated with well-known functions or configurations will be omitted when they may make subject matters of the present disclosure unnecessarily obscure.

In describing elements of an implementation of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms used herein, including technical or scientific terms, include the same meaning as commonly understood by one of ordinary skill in the technical field to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

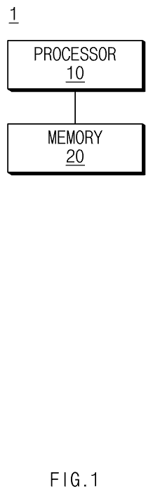

Hereinafter, implementations of the present disclosure will be described in detail with reference to FIGS. 1 to 8.

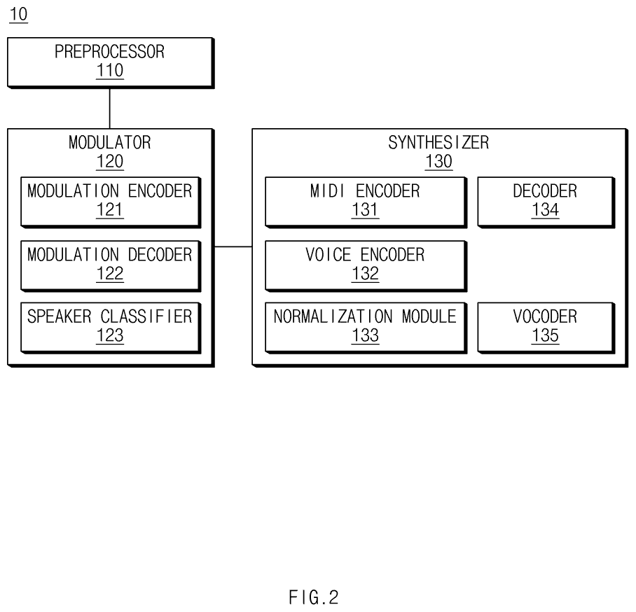

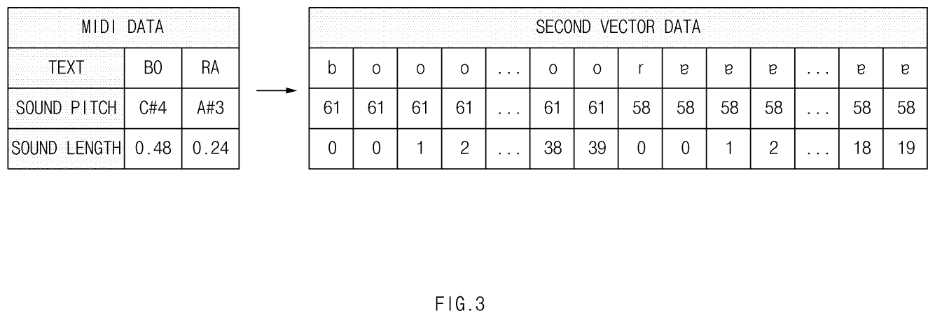

FIG. 1 is a block diagram showing an example configuration of a synthesis device 1 for synthesizing a singing voice, according to an implementation of the present disclosure. FIG. 2 is a block diagram showing an example configuration of a processor 10, according to an implementation of the present disclosure. FIG. 3 is a drawing illustrating an example of an operation of a synthesizer 130, according to an implementation of the present disclosure.

Referring to FIG. 1, the synthesis device 1 of a singing voice may include at least one processor and at least one memory, e.g., processor 10 and memory 20.

The processor 10 may synthesize a singing voice based on raw voice data of any speaker. For example, the speaker may be an ordinary person, not a specific singer known to the public. The raw voice data may include a singing voice of any speaker. Furthermore, the raw voice data may also include conversational voices from any speaker.

The processor 10 will be described in detail later with reference to FIG. 2.

The processor 10 may control the synthesis device 1 and may execute at least one instruction stored in connection with the memory 20.

The memory 20 may store an operating system (OS) for controlling the overall operations of components of the processor 10 and at least one command or data related to components of the processor 10.

The memory 20 may include a non-volatile memory such as an ROM, a flash memory, or the like and may include a volatile memory composed of a DRAM. Besides, the memory 20 may include a hard disk, a solid state drive (SSD), or the like.

Referring to FIG. 2, the processor 10 may include a preprocessor 110, a modulator 120, and the synthesizer 130.

In an implementation, the preprocessor 110 may input raw voice data and musical score data (e.g., MIDI data). Here, the musical score data may include data that expresses music information, such as a music score, in a digital format such as MIDI format. For purposes of discussion, examples of the musical score data as MIDI data are described, but implementations are not limited thereto. Based on the raw voice data and the MIDI data, the processor 110 can extract voice feature data and MIDI feature data, respectively.

The preprocessor 110 may extract voice feature data based on the input raw voice data. In some implementations, the voice feature data may include, but is not limited to, spectrogram data and pitch data. In some implementations, the spectrogram data and the pitch data may be extracted based on predetermined hyperparameters. For example, the preprocessor 110 may normalize the raw voice data by converting the raw voice data to a value from 1.0 to a floating point (float) value in a range of 1.0. Moreover, the preprocessor 110 may set the raw voice data in time unit of about 0.01 seconds to 1 frame based on the predetermined hyperparameters. In this case, the spectrogram data may be data obtained by converting the raw voice data of 1 frame by Short Time Fourier Transform (STFT). Also, the pitch data may be calculated based on the raw voice data of 1 frame described above.

The preprocessor 110 may extract MIDI feature data based on the input MIDI data. In some implementations, the MIDI feature data may include height feature data from converting sound pitch, length feature data from converting a sound length, and phoneme feature data from converting text. For example, the preprocessor 110 may convert the sound pitch to a number. The preprocessor 110 may set C4, which is the basis of the music score, to 60. C#4 may be converted to 61, and A3 may be converted to 57. Accordingly, the preprocessor 110 may convert all pieces of sound pitch included in the MIDI data into numbers, and the converted numbers may be included in the pitch feature data. Alternatively, for example, the preprocessor 110 may convert a sound length to a number. The preprocessor 110 may convert sound lengths into numbers being physical time data based on the tempo, beats, and notes included in the music score. Afterwards, the preprocessor 110 may convert the converted number data to include the same 1 frame unit as spectrogram, and the converted number may be included in the length feature data. Alternatively, for example, the preprocessor 110 may convert text matching sounds into phonemes. The preprocessor 110 may convert ‘hakkjo’ (which means “school” in Korean) to ‘/hak/, /kjo/’, and the converted phonemes may be included in the phoneme feature data.

In an implementation, after the preprocessor 110 extracts the voice feature data based on the input raw voice data, the modulator 120 may then extract modulation voice data, based on voice feature data that is input from the preprocessor 110.

The modulator 120 may include, for example, a modulation encoder 121, a modulation decoder 122, and a speaker classifier 123.

In an implementation, the modulation encoder 121 may encode the spectrogram data that is received from the preprocessor 110 into first vector data including time data. For example, the modulation encoder 121 may extract the first vector data including time data of a certain range from the spectrogram data. For example, the modulation encoder 121 may extract the first vector data using multiple convolution layers. In some implementations, the first vector data may include latent vector extracted from the spectrogram data.

In scenarios where the convolution layer of the modulation encoder 121 is a convolution layer of WaveNet, one of the multiple convolution layers may include a sub-component consisting of Weight Normalized Convolution (WN Conv.), Residual Connection, and Skip Connection. In some implementations, the WN Conv. may be a one-dimensional convolution layer, and may learn only the direction while adjusting the size of a parameter. The Residual Connection may be a connection method of adding the operation result of the WN Conv. and an input. The Skip Connection may be a connection method of creating a bypass path directly connected to the final output. For example, the WN Conv. of the N-th convolution layer may recompute (N−1)-th spectrogram data input to the (N−1)-th convolution layer that is the previous convolution layer. Afterwards, the WN Conv. may deliver the recomputed result data to the Residual Connection and the Skip Connection. Afterwards, Residual Connection may compute the result data recomputed by the WN Conv. Afterwards, Residual Connection may calculate N-th spectrogram data by adding the computed result to (N−1)-th spectrogram data. Afterwards, the modulation encoder 121 may input the N-th spectrogram data to the next convolution layer, the (N+1)-th convolution layer. In some implementations, the Skip Connection may compute the (N−1)-th spectrogram data input to the WN Conv. Afterwards, the Skip Connection may output the computed result through a bypass path.

After repeating the above-described process, the modulation encoder 121 may add all of pieces of first vector data, which are the output values of multiple convolution layers. Afterwards, the modulation encoder 121 may calculate the mean and variance of the pieces of first vector data based on the added result. Afterwards, the modulation encoder 121 may calculate a probability distribution of the pieces of first vector data based on the mean and variance of the pieces of first vector data. Accordingly, the modulation encoder 121 may solve the gradient loss problem while the raw voice data is simultaneously included in the first vector data.

In an implementation, the modulation decoder 122 may decode the first vector data and the pitch data into modulation voice data. For example, the modulation decoder 122 may receive the pitch data and a speaker label from the preprocessor 110, and may receive sample data of the first vector data from the modulation encoder 121. Afterwards, the modulation decoder 122 may extract modulation voice data from the received first vector data, pitch data, and speaker label by using multiple convolution layers. The modulation voice data can be an output of the decoder 122 attempting to reconstruct the raw voice data input based on the extracted first vector data. In some implementations, weight normalization may be applied to the multiple convolution layers. Accordingly, the gradient loss problem may be solved while learning stability is ensured.

The modulation decoder 122 may reduce a difference in sequence length between the first vector data and the modulation voice data by computing the first vector data by using a convolution layer with a certain layer. For example, the first vector data may be data with a relatively short period as a latent vector, and the modulation voice data may be detailed data with a relatively long period. In some implementations, there may be a difference between the sequence length of the first vector data and the sequence length of the modulation voice data. The modulation decoder 122 may use a convolution layer with a predetermined layer that performs an up-sampling operation. For example, because the convolution layer of the modulation decoder 122 may perform a transposed convolution operation, the temporal resolution of the first vector data may be increased by a predetermined magnification. In some implementations, the predetermined magnification may be determined based on the number of sample data of the modulation voice data and the time ratio of 1 frame of the first vector data. Accordingly, the modulation decoder 122 may reduce the difference between the sequence length of the first vector data and the sequence length of the modulation voice data. Moreover, the modulation decoder 122 may obtain the correlation between the first vector data and the modulation voice data in consideration of information of a longer time sequence than the spectrogram data by applying dilation to the convolution layer.

The modulation decoder 122 may perform learning so as to reduce an error between first spectrogram data extracted from the raw voice data and second spectrogram data extracted from the modulation voice data by using a first loss function. In some implementations, the first loss function may include, but is not limited to, Mean Absolute Error (MAE), Generator loss, Discriminator loss, feature loss using in GAN(HiFi-GAN(High-Fidelity Generative Adversarial Network). For example, the modulation decoder 122 may receive raw voice data and the first spectrogram corresponding to the raw voice data from the preprocessor 110. Furthermore, the modulation decoder 122 may learn the first spectrogram and the second spectrogram to a learning model that applies the first loss function. The modulation decoder 122 may reduce the error between the first spectrogram and the second spectrogram by repeating the learning. Accordingly, the modulation decoder 122 may improve the quality of modulation voice data in consideration of time and frequency.

In an implementation, the speaker classifier 123 may predict the arbitrary speaker based on the first vector data. For example, the speaker classifier 123 may receive sample data of the first vector data from the modulation encoder 121. Afterwards, the speaker classifier 123 may calculate the average of time steps from the first vector data by using multiple convolution layers, and may predict an arbitrary speaker based on the calculated result. In some implementations, the arbitrary speaker may be pre-stored in the speaker classifier 123. In this case, the speaker classifier 123 may generate a gradient while being learned to predict the speaker, which may affect the modulation encoder 121 that extracts the first vector data. Accordingly, the speaker classifier 123 may be used to learn the first vector data.

The speaker classifier 123 may include a Gradient Reversal Layer (GRL) that removes speaker data from the first vector data. For example, in some scenarios, the first vector data received from the modulation encoder 121 may include speaker data. However, when the speaker data is present in the first vector data, problems can occur in that the performance of the modulator 120 may deteriorate. As an example of such problems, the modulator 120 may input spectrogram data corresponding to an arbitrary speaker into the modulation encoder 121 to extract the first vector data, which is then input, along with the speaker label, to the modulation decoder 122 to extract the modulation voice data. In this case, there is a risk of mismatch between the speaker data and the speaker label. This mismatch can occur because the synthesis device 1 is designed to independently synthesize the singing voice without relying on a particular speaker. However, due to this mismatch, a conflict or collision may occur between the speaker data and the speaker label in the modulator 120, thereby reducing the quality of the modulation voice data. To address these issues, the speaker classifier 123 may remove the speaker data from the first vector data, e.g., by using the GRL. As a specific example, the GRL may still deliver an input value as an output value at a forward time point. For example, the output value may be “y=−x (x is the input value)”. In some implementations, the GRL may multiply −0.1 when calculating the gradient based on the error between the input and output values at a backward time point. Through the above process, the speaker classifier 123 can remove the speaker data from the first vector data as learning progresses. Accordingly, the speaker classifier 123 may induce the modulation decoder 122 to instead use the speaker label that is separately input to the modulation decoder 122 during deployment.

In an implementation, the synthesizer 130 may synthesize a singing voice based on voice feature data and MIDI feature data.

The synthesizer 130 may include a MIDI encoder 131, a voice encoder 132, a normalization module 133, a decoder 134, and a vocoder 135. In an implementation, the voice encoder 132 may not essential component in the synthesizer 130, the voice encoder 132 may be included in the synthesizer 130 for voice selection when multiple voices are synthesized.

In an implementation, the MIDI encoder 131 may encode MIDI feature data into second vector data by using an embedding layer. For example, the MIDI encoder 131 may receive MIDI feature data from the preprocessor 110. Afterwards, the MIDI encoder 131 may extract the second vector data with the same size from each of pieces of MIDI feature data.

An example of extracting the second vector data is shown in FIG. 3. Referring to FIG. 3, the text ‘bo’ and ‘ra’ of MIDI data may be converted into phonemes in the preprocessor 110, and sound heights ‘C #4’ and ‘A #3’ of MIDI data may be converted into height feature data in the preprocessor 110. Moreover, sound lengths of MIDI data ‘0.48’ and ‘0.24’ may be converted into length feature data in the preprocessor 110. Afterwards, the MIDI encoder 131 may convert each of a phoneme and height feature data into its own index, and may convert the unique index into the second vector data through the embedding layer. Furthermore, the MIDI encoder 131 may convert time data of length feature data into location data, and may convert location data of length feature data into the second vector data through the embedding layer. In this case, the MIDI encoder 131 may expand the length of the second vector data based on the length of the length feature data. As illustrated in FIG. 3, the second vector data may include a vector sequence.

Referred back to FIG. 2, after extracting the second vector data, the MIDI encoder 131 may calculate the probability distribution of the second vector data by learning the encoded second vector data through a learning model. Here, the learning model may include, but is not limited to, a transformer. For example, the MIDI encoder 131 may expand the vector sequence of the encoded second vector data and may input the expanded vector sequence to a multi-layer transformer block. Here, the transformer block may reflect the correlation between pieces of second vector data based on a self-attention structure. Here, the transformer block may include a feed-forward network (FFN) with a bottleneck structure. In other words, the FFN of the bottleneck structure performs high-dimensional expansion and reduction operations, thereby removing noise from the second vector data. Afterwards, the MIDI encoder 131 may calculate the mean and variance of the pieces of second vector data from which the noise is removed. Afterwards, the MIDI encoder 131 may calculate a probability distribution of the pieces of second vector data based on the mean and variance of the pieces of second vector data.

In an implementation, the voice encoder 132 may encode spectrogram data into first vector data including time data. Afterwards, the voice encoder 132 may calculate the probability distribution of the encoded first vector data by using a convolution layer. In some implementations, the voice encoder 132 may include the same configuration as the modulation encoder 121 of the modulator 120. For example, the voice encoder 132 may receive the spectrogram data from the preprocessor 110. Assuming that the convolution layer of the voice encoder 132 is a convolution layer of WaveNet, one of the multiple convolution layers may include a sub-component consisting of a Weight Normalized Convolution (WN Conv.), a Residual Connection, and a Residual Connection. In some implementations, the WN Conv. may be a one-dimensional convolution layer, and may learn only the direction while adjusting the size of a parameter. The Residual Connection may be a connection method of adding the operation result of the WN Conv. and an input. The Skip Connection may be a connection method of creating a bypass path directly connected to the final output. For example, the WN Conv. of the N-th convolution layer may recompute (N−1)-th spectrogram data input to the (N−1)-th convolution layer that is the previous convolution layer. Afterwards, the WN Conv. may deliver the recomputed result data to the Residual Connection and the Skip Connection. Afterwards, Residual Connection may compute the result data recomputed by the WN Conv. Afterwards, Residual Connection may calculate N-th spectrogram data by adding the computed result to (N−1)-th spectrogram data. Afterwards, the modulation encoder 121 may input the N-th spectrogram data to the next convolution layer, the (N+1)-th convolution layer. In some implementations, the Skip Connection may compute the (N−1)-th spectrogram data input to the WN Conv. Afterwards, the Skip Connection may output the computed result through a bypass path.

After repeating the above-described process, the voice encoder 132 may add all of pieces of first vector data, which are the output values of multiple convolution layers. Afterwards, the voice encoder 132 may calculate the mean and variance of the pieces of first vector data based on the added result. Afterwards, the voice encoder 132 may calculate a probability distribution of the pieces of first vector data based on the mean and variance of the pieces of first vector data. The voice encoder 132 may match the probability distribution of the first vector data with the probability distribution of the second vector data by using a normalizing flow.

In an implementation, the normalization module 133 may transform the second vector data by using the normalizing flow. Afterwards, the normalization module 133 may match the probability distribution of the second vector data with the probability distribution of the first vector data. In some implementations, the probability distribution of the first vector data (extracted from the voice data) is based on more complex data dependent on physical speech phenomena, and thus the first vector data may include a complex probability distribution. In some implementations, the probability distribution of the second vector data (extracted from the MIDI data) is based on more structured musical data, and thus the second vector data may include a relatively simple probability distribution. Accordingly, the normalization module 133 may use a normalizing flow to match the probability distribution of the first vector data with the probability distribution of the second vector data for synthesizing a singing voice. In particular, the normalizing flow may be composed of a flow block of multiple layers. During training, the flow block may divide the input vector A (the probability distribution of the first vector) into two halves and apply invertible transformations to each half. For example, an identity transformation can be applied to one half and the other half can be transformed using, for example, scaling and shifting. Afterwards, the flow block may concatenate the transformed two halves of the vector A to generate an output of the layer. As discussed above, the flow block may apply an identity transformation to fix one half of the vector A and may apply scaling and shifting transformations to the other half of the vector A. After concatenation, the flow block may perform a flip operation based on a vector dimension. Through the flip operation, the half that was previously transformed may be fixed and the half that was previously fixed is transformed in the next flow block. Through the above-described process, the normalization module 133 may gradually match the estimated probability distribution of the second vector data (i.e., the probability distribution of the output of the normalization module 133 during training, generated based on samples of the first vector data) with the actual probability distribution of the second vector data.

The normalization module 133 may perform learning by using the second loss function. In some implementations, the second loss function may include, but is not limited to, Kullback-Leibler (KL) divergence. For example, the normalization module 133 may perform learning to output an estimate that matches the sample data of the second vector data output by the MIDI encoder 131, by inputting the first vector data output by the voice encoder 132. As such, during learning, the KL divergence can used to ensure that the output from the flow in the normalization module 133 matches the musical score encoding distribution. Afterwards, during deployment, the second vector data is inputto the learned normalization module 133, and the inverse operations of the trained normalization flow may be utilized to output an estimate of the sample data of the first vector data. In particular, during training, the normalization module 133 may perform learning to match the probability distribution of the output of the normalization module 133 (based on samples of the first vector data) with the actual probability distribution of the second vector data, e.g., by using the KL divergence. This may be expressed based on an equation.

Lₖₗ=log q (Z|S)−log p (Z_{θ}|C), Z~q (Z|S)=N(Z; μ(s), σ(s)).

Here, ‘q’ may denote the probability distribution of the first vector data conditioned on raw voice data at a voice encoder; ‘p’ may denote the probability distribution of the second vector data conditioned on the MIDI data at a MIDI encoder; ‘Z’ may denote the first vector data; ‘S’ may denote the raw voice data; ‘Z_{θ}’ may denote the second vector data; ‘C’ may denote the MIDI data, and ‘N’ denotes a Gaussian distribution for Z with mean μ(s) and standard deviation σ(s).

In an implementation, after training the during deployment, the decoder 134 may generate Mel-spectrogram based on the probability distribution of the first vector data and the probability distribution of the second vector data, which are matched with each other. For example, during deployment, the decoder 134 can obtain a matched first vector data that is output from the trained normalization module 133 (which generates the matched first vector data based on applying an inverse flow operation to an input second vector data). In some implementations, the decoder 134 may include the same configuration as the modulation decoder 122 of the modulator 120. For example, the Mel-spectrogram may include a spectrum that converts the frequency component distribution of voice over time based on a Mel-scale. Accordingly, the Mel spectrogram may include data such as rhythm, pitch, and accent of the singing voice.

Afterwards, the vocoder 135 may synthesize a singing voice based on the Mel spectrogram.

Accordingly, even though an arbitrary speaker does not record the singing voice, when the singing voice is required for the voice of an arbitrary speaker, the synthesis device 1 of the singing voice according to an implementation of the present disclosure may synthesize the singing voice. In particular, the synthesis device 1 may synthesize the singing voice of any ordinary person, not a singer, in consideration of all of the beats, pitches, or the like included in the music score.

As described above, the synthesis device 1 of a singing voice may synthesize arbitrary voice data of an ordinary person into the singing voice without a process of transcribing a music score. Moreover, the synthesis device 1 of a singing voice may synthesize a speaker's singing voice in a language other than the language that the speaker is capable of speaking.

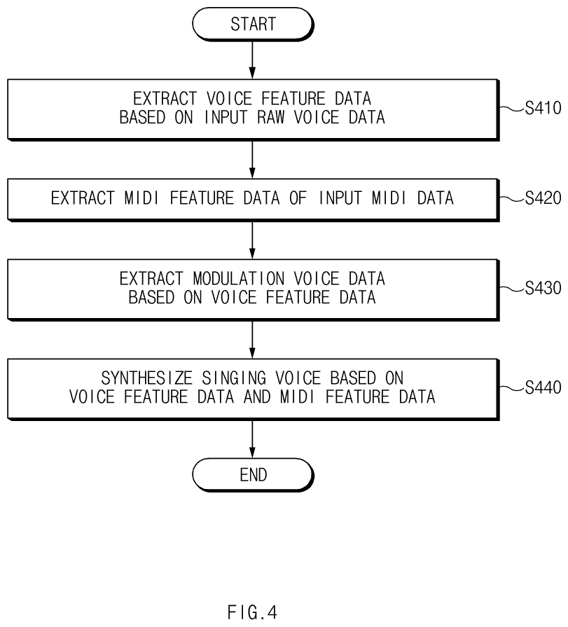

FIGS. 4 to 9 are flowcharts for describing an example of an operation of the synthesis device 1 of a singing voice, according to an implementation of the present disclosure.

FIG. 4 is a flowchart illustrating an example of a synthesis method of the synthesis device 1 of a singing voice, according to an implementation of the present disclosure.

Referring to FIG. 4, in S410, voice feature data may be extracted based on input raw voice data. For example, the preprocessor 110 may receive raw voice data and may extract voice feature data. Here, the voice feature data may include, but is not limited to, spectrogram data and pitch data.

In S420, MIDI feature data of the input MIDI data may be extracted. For example, the preprocessor 110 may receive MIDI data and may extract MIDI feature data. Here, the MIDI feature data may include height feature data from converting sound pitch, length feature data from converting a sound length, and phoneme feature data from converting text.

In S430, modulation voice data may be extracted based on the voice feature data. For example, the modulator 120 may extract modulation voice data based on voice feature data input from the preprocessor 110.

In S440, a singing voice may be synthesized based on the voice feature data and the MIDI feature data. For example, the synthesizer 130 may synthesize a singing voice based on voice feature data and MIDI feature data.

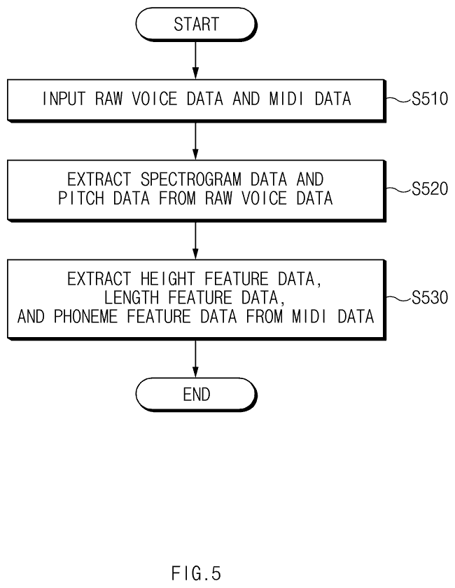

FIG. 5 is a flowchart for describing an example of an operation of the preprocessor 110, according to an implementation of the present disclosure. In particular, FIG. 5 shows an example of extracting voice feature data and MIDI feature data (e.g., as in S410 and S420 of FIG. 4).

Referring to FIG. 5, in S510, raw voice data and MIDI data may be input. For example, the preprocessor 110 may input raw voice data and MIDI data. Here, the MIDI data may include data that expresses music information, such as a music score, in digital format.

In S520, voice feature data can be extracted from the raw voice data (e.g., as in S410 in FIG. 4). For example, the voice feature data can include spectrogram data and pitch data, which may be extracted from the raw voice data. In some implementations, the spectrogram data and the pitch data may be extracted based on predetermined hyperparameters. For example, the preprocessor 110 may normalize the raw voice data by converting the raw voice data to a value from 1.0 to a floating point (float) value in a range of 1.0. Moreover, the preprocessor 110 may set the raw voice data in unit of about 0.01 seconds to 1 frame based on the predetermined hyperparameters. In this case, the spectrogram data may be data obtained by converting the raw voice data of 1 frame by Short Time Fourier Transform (STFT). Also, the pitch data may be calculated based on the raw voice data of 1 frame described above.

In S530, MIDI feature data can be extracted from the MIDI data (e.g., as in S420 of FIG. 4). The MIDI feature data can include height feature data, length feature data, and phoneme feature data, which may be extracted from MIDI data. Here, the MIDI feature data may include height feature data from converting sound pitch, length feature data from converting a sound length, and phoneme feature data from converting text. For example, the preprocessor 110 may convert the sound pitch to a number. The preprocessor 110 may set C4, which is the basis of the music score, to 60. C#4 may be converted to 61, and A3 may be converted to 57. Accordingly, the preprocessor 110 may convert all pieces of sound pitch included in the MIDI data into numbers, and the converted numbers may be included in the pitch feature data. Alternatively, for example, the preprocessor 110 may convert a sound length to a number. The preprocessor 110 may convert sound lengths into numbers being physical time data based on the tempo, beats, and notes included in the music score. Afterwards, the preprocessor 110 may convert the converted number data to include the same 1 frame unit as spectrogram, and the converted number may be included in the length feature data. Alternatively, for example, the preprocessor 110 may convert text matching sounds into phonemes. The preprocessor 110 may convert ‘hakkjo’ (which means “school” in Korean) to ‘/hak/, /kjo/’, and the converted phonemes may be included in the phoneme feature data.

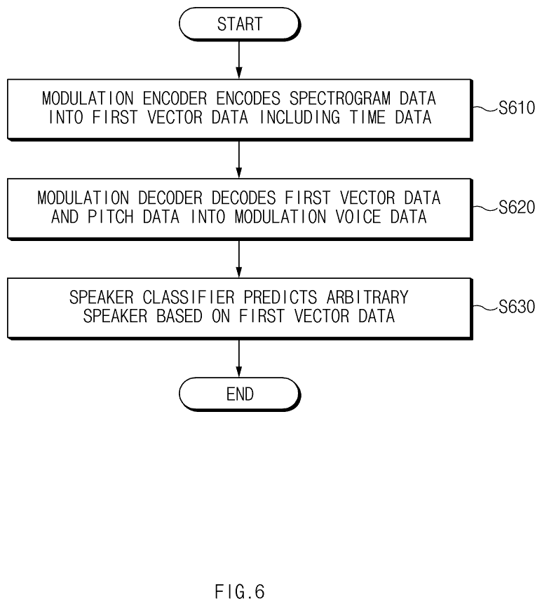

FIG. 6 is a flowchart for describing an example of an operation of the modulator 120, according to an implementation of the present disclosure. The modulator 120 may include a modulation encoder 121, a modulation decoder 122, and a speaker classifier 123.

Referring to FIG. 6, in S610 and S620, the modulator 120 can extract modulation voice data from voice feature data, where the voice feature data can include spectrogram data and pitch data (e.g., as in S430 of FIG. 4). In particular, in S610, the modulation encoder 121 may encode the spectrogram data into first vector data including time data. For example, the first vector data may include a latent vector extracted from the spectrogram data.

In S620, the modulation decoder 122 may decode the first vector data and the pitch data into modulation voice data. For example, the modulation decoder 122 may extract the modulation voice data from the received first vector data, pitch data, and speaker label by using multiple convolution layers.

In S630, the speaker classifier 123 may predict an arbitrary speaker based on the first vector data. For example, the speaker classifier 123 may receive sample data of the first vector data from the modulation encoder 121. Afterwards, the speaker classifier 123 may calculate the average of time steps from the first vector data by using multiple convolution layers, and may predict an arbitrary speaker based on the calculated result.

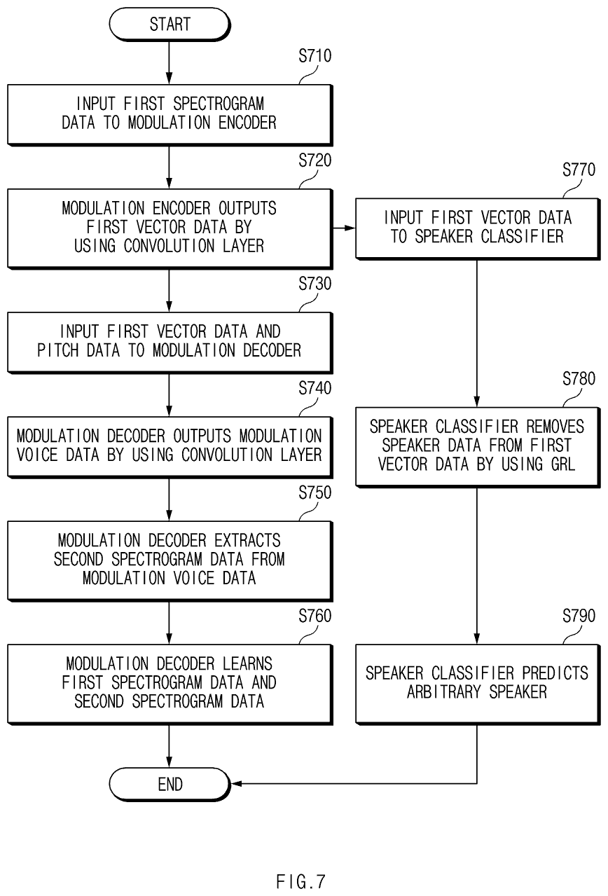

FIG. 7 is a flowchart for describing an example of training the modulator 120, according to an implementation of the present disclosure. The training of FIG. 7 can be used, for example, to train the modulator 120 that performs the operations of FIGS. 5 and 6.

Referring to FIG. 7, in S710, first spectrogram data may be input to the modulation encoder 121. For example, the modulation encoder 121 may receive the first spectrogram data from the preprocessor 110. In some implementations, the first spectrogram data may be extracted from raw voice data.

In S720, the modulation encoder 121 may output first vector data by using a convolution layer. For example, the modulation encoder 121 may extract the first vector data including a predetermined range of time data from the first spectrogram data. Afterwards, the modulation encoder 121 may add all of the pieces of first vector data, which are the output values of multiple convolution layers. Afterwards, the modulation encoder 121 may calculate the mean and variance of the pieces of first vector data based on the added result. Afterwards, the modulation encoder 121 may calculate a probability distribution of the pieces of first vector data based on the mean and variance of the pieces of first vector data. Accordingly, the modulation encoder 121 may solve the gradient loss problem while the raw voice data is simultaneously included in the first vector data.

In S730, the first vector data and pitch data may be input to the modulation decoder 122. For example, the modulation decoder 122 may receive the pitch data and a speaker label from the preprocessor 110, and may receive sample data of the first vector data from the modulation encoder 121.

In S740, the modulation decoder 122 may output modulation voice data by using the convolution layer. For example, the modulation decoder 122 may extract the modulation voice data from the received first vector data, pitch data, and speaker label by using multiple convolution layers. In some implementations, weight normalization may be applied to the multiple convolution layers. Accordingly, the gradient loss problem may be solved while learning stability is ensured.

In S750, the modulation decoder 122 may extract second spectrogram data from the modulation voice data.

In S760, the modulation decoder 122 may learn the first spectrogram data and the second spectrogram data. For example, the modulation decoder 122 may perform learning so as to reduce an error between the first spectrogram data and the second spectrogram data by using a first loss function. Here, the first loss function may include, but is not limited to, Mean Absolute Error (MAE).

Meanwhile, in S770, the first vector data output in S720 may also be input to the speaker classifier 123. For example, the speaker classifier 123 may receive sample data of the first vector data from the modulation encoder 121.

In S780, the speaker classifier 123 may remove speaker data from the first vector data by using Gradient Reversal Layer (GRL). For example, in some scenarios, the first vector data received from the modulation encoder 121 may include speaker data. However, when the speaker data is present in the first vector data, the performance of the modulator 120 may deteriorate. For example, the modulator 120 may input spectrogram data corresponding to an arbitrary speaker into the modulation encoder 121 to extract the first vector data which is then input, along with the speaker label, to the modulation decoder 122 to extract the modulation voice data. In this case, there is a risk of mismatch between the speaker data and the speaker label. This mismatch can occur because the synthesis device 1 is designed to independently synthesize the singing voice without relying on a particular speaker. However, due to this mismatch, a conflict or collision may occur between the speaker data and the speaker label in the modulator 120, thereby reducing the quality of the modulation voice data. To address these issues, the speaker classifier 123 can remove the speaker data from the first vector data, e.g., by using the GRL. As a specific example, the GRL may still deliver an input value as an output value at a forward time point. For example, the output value may be “y=−x (x is the input value)”. In some implementations, the GRL may multiply −0.1 when calculating the gradient based on the error between the input and output values at a backward time point. Through the above process, the speaker classifier 123 may remove the speaker data from the first vector data as learning progresses. Accordingly, the speaker classifier 123 may induce the modulation decoder 122 to instead use the speaker label that is separately input to the modulation decoder 122 during deployment.

In S790, the speaker classifier 123 may predict an arbitrary speaker. For example, the speaker classifier 123 may calculate the average of time steps from the first vector data by using multiple convolution layers, and may predict an arbitrary speaker based on the calculated result. In some implementations, the arbitrary speaker may be pre-stored in the speaker classifier 123. In this case, the speaker classifier 123 may generate a gradient while being trained to predict the speaker, which may affect the modulation encoder 121 that extracts the first vector data. The gradient generated while learning to distinguish between speakers and singers passes through the latent layer and ultimately affects the modulation encoder 121. Accordingly, the speaker classifier 123 may be used to learn the first vector data.

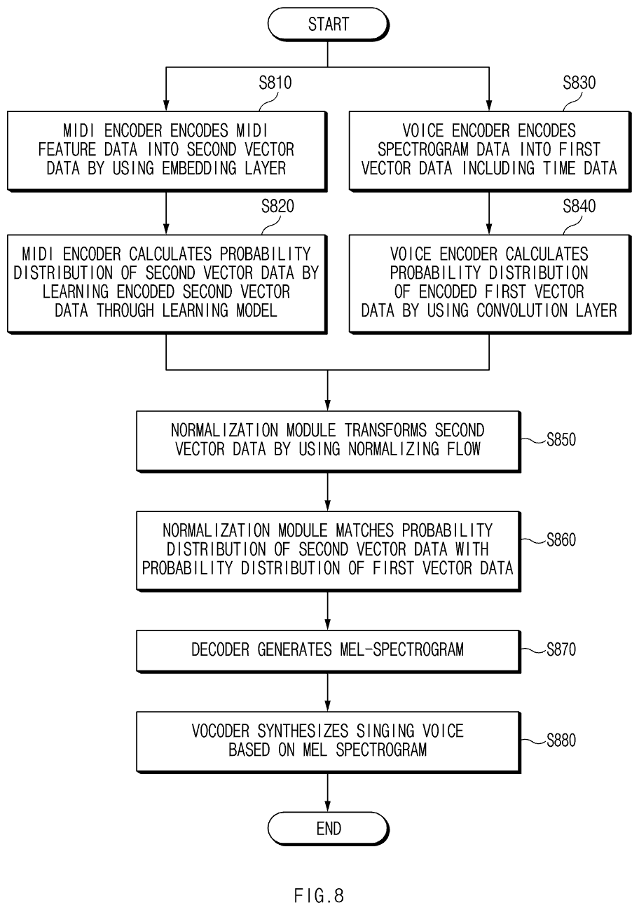

FIG. 8 is a flowchart for describing an example of an operation of the synthesizer 130, according to an implementation of the present disclosure.

Referring to FIG. 8, in S810, the MIDI encoder 131 may encode MIDI feature data into second vector data by using an embedding layer. For example, the MIDI encoder 131 may receive MIDI feature data from the preprocessor 110 (e.g., as a result of S530 in FIG. 5). Afterwards, the MIDI encoder 131 may extract the second vector data with the same size from each of pieces of MIDI feature data.

In S820, the MIDI encoder 131 may calculate the probability distribution of the second vector data by learning the encoded second vector data through a learning model. The learning model may include, but is not limited to, a transformer. For example, the MIDI encoder 131 may expand the vector sequence of the encoded second vector data and may input the expanded vector sequence to a multi-layer transformer block. Here, the transformer block may reflect the correlation between second vector data based on the self-attention structure. In some implementations, the transformer block may include a feed-forward network (FFN) with a bottleneck structure. For example, the FFN of the bottleneck structure performs high-dimensional expansion and reduction operations, thereby removing noise from the second vector data. Afterwards, the MIDI encoder 131 may calculate the mean and variance of the pieces of second vector data from which the noise is removed. Afterwards, the MIDI encoder 131 may calculate a probability distribution of the pieces of second vector data based on the mean and variance of the pieces of second vector data.

In some implementations, in S830, the voice encoder 132 (e.g., which can include the same configuration as the modulation encoder 121 in FIG. 2) may encode spectrogram data into first vector data including time data. For example, the voice encoder 132 may receive the spectrogram data from the preprocessor 110 (e.g., as a result of S520 in FIG. 5). Afterwards, the voice encoder 132 may extract the first vector data including time data of a certain range from the spectrogram data. Here, the voice encoder 132 may be the same as or include the same configuration as the modulation encoder 121 of the modulator 120 (and S830 may be the same as S610 of FIG. 6).

In S840, the voice encoder 132 may calculate the probability distribution of the encoded first vector data by using a convolution layer. For example, the voice encoder 132 may add all of the pieces of first vector data, which are the output values of multiple convolution layers. Afterwards, the voice encoder 132 may calculate the mean and variance of the pieces of first vector data based on the added result. Afterwards, the voice encoder 132 may calculate a probability distribution of the pieces of first vector data based on the mean and variance of the pieces of first vector data. At the same time, the voice encoder 132 may match the probability distribution of the first vector data with the probability distribution of the second vector data by using a normalizing flow.

In S850, the normalization module 133 may transform the second vector data by using the normalizing flow (e.g., as described with reference to FIG. 2).

In S860, the normalization module 133 may match the probability distribution of the second vector data with the probability distribution of the first vector data (e.g., as described with reference to FIG. 2). In some implementations, the probability distribution of the first vector data is based on physical data, and thus the first vector data may include a complex probability distribution. In some implementations, because the probability distribution of the second vector data is based on abstract data, the second vector data may include a relatively simple probability distribution. Accordingly, the normalization module 133 may match the probability distribution of the first vector data with the probability distribution of the second vector data for synthesizing a singing voice. The normalization module 133 may have been previously trained to learn to match the probability distribution of the first vector data with the probability distribution of the second vector data by using the second loss function, as described with reference to FIG. 2.

In S870, the decoder 134 (e.g., which can include the same configuration as the modulation decoder 122 in FIG. 2) may generate Mel-spectrogram based on the probability distribution of the first vector data and the probability distribution of the second vector data.

In S880, the vocoder 135 may synthesize a singing voice based on the Mel spectrogram.

Accordingly, even though an arbitrary speaker does not record the singing voice, when the singing voice is required for the voice of an arbitrary speaker, the synthesis device 1 according to an implementation of the present disclosure may synthesize the singing voice. In particular, the synthesis device 1 may synthesize the singing voice of any ordinary person, not a singer, in consideration of all of the beats, pitches, or the like included in the music score.

As described above, a synthesis method of the synthesis device 1 of a singing voice may synthesize arbitrary voice data of an ordinary person into the singing voice without a process of transcribing a music score. Moreover, the synthesis method of the synthesis device 1 of a singing voice may synthesize a speaker's singing voice in a language other than the language that the speaker is capable of speaking.

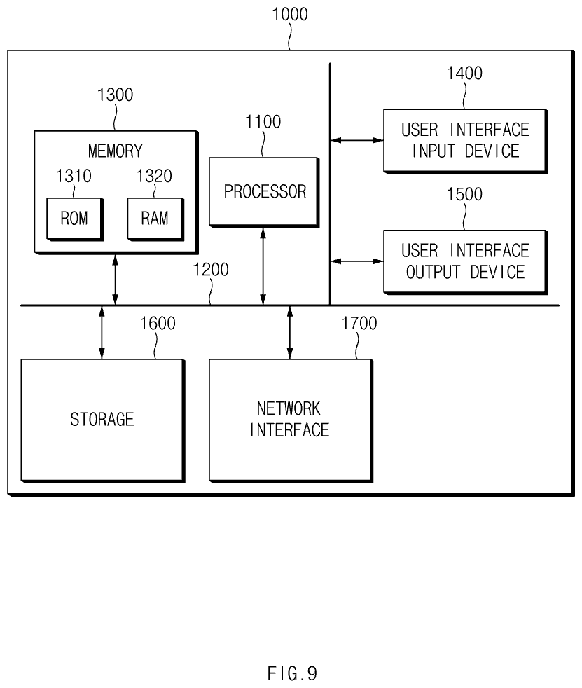

FIG. 9 is a block diagram illustrating an example of a computing system 1000, according to an implementation of the present disclosure.

Referring to FIG. 9, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the implementations disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The user interface input device 1400 may include an input device for receiving a user input.

For example, the input device may be a tact switch, a joystick, a push switch, a slide switch, a toggle switch, a micro switch, or a touch screen. Moreover, the input device may include a microphone for receiving a voice input of a user.

The user interface output device 1500 may include a display that displays various types of information, and a speaker that outputs various types of sounds. Here, the display may provide a user interface through which the computing system 1000 interacts with the user. For example, the display may include a liquid crystal display (LCD) panel and/or a light emitting diode (LED).

The network interface 1700 may include a long-range communication module and/or a short-range communication module for exchanging data with an external device (e.g., a server 2 or a user terminal). For example, the network interface 1700 may include a communication module capable of performing wireless Internet communication such as Wireless LAN (WLAN), Wireless Broadband (Wibro), WiFi, World Interoperability for Microwave Access (Wimax), and High Speed Downlink Packet Access (hsdpa).

The above description is merely an example of the technical idea of the present disclosure, and various modifications and variations may be made by one skilled in the art without departing from the essential characteristic of the present disclosure.

Accordingly, implementations of the present disclosure are intended not to limit but to explain the technical idea of the present disclosure, and the scope and spirit of the present disclosure is not limited by the above implementations. The scope of protection of the present disclosure should be construed by the attached claims, and all equivalents thereof should be construed as being included within the scope of the present disclosure.

The present technology may synthesize arbitrary voice data of an ordinary person into a singing voice without a process of transcribing a music score.

Moreover, the present technology may synthesize a speaker's singing voice in a language other than the language that the speaker is capable of speaking.

In addition, a variety of effects directly or indirectly understood via the present disclosure may be provided.

Hereinabove, although the present disclosure was described with reference to example implementations and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A synthesis device configured to synthesize a singing voice, the synthesis device comprising:
at least one processor; and
at least one memory storing computer program instructions that, based on being executed by the at least one processor, perform operations of synthesizing the singing voice of a speaker, the operations comprising:
obtaining raw voice data and musical instrument digital interface (MIDI) data;
extracting voice feature data based on the raw voice data;
extracting MIDI feature data from the MIDI data;
performing training of a first machine-learning network, wherein the training comprises generating modulation voice data with the first machine-learning network based on the voice feature data and adjusting parameters of the first machine-learning network based on the modulation voice data; and
synthesizing the singing voice by generating an audio waveform with the trained first machine-learning network based on the MIDI feature data.

2. The synthesis device of claim 1, wherein the voice feature data includes pitch data and spectrogram data extracted based on at least one hyperparameter, and
wherein the MIDI feature data includes height feature data from converting sound pitch, length feature data from converting a sound length, and phoneme feature data from converting text.

3. The synthesis device of claim 2, wherein the training of the first machine-learning network comprises:
encoding, with a voice encoder neutral network, the spectrogram data into first vector data including time data;
decoding, with a voice decoder neural network, the first vector data and the pitch data to generate the modulation voice data; and
predicting, with a speaker classifier neural network, the speaker based on the first vector data.

4. The synthesis device of claim 3, wherein each of the voice encoder neural network and the voice decoder neural network includes at least one convolution layer.

5. The synthesis device of claim 3, wherein the training of the machine-learning network comprises:
training the voice decoder neural network to reduce an error between first spectrogram data extracted from the raw voice data and second spectrogram data generated from the modulation voice data, wherein the error is based on a first loss function.

6. The synthesis device of claim 5, wherein the first loss function includes a mean absolute error (MAE).

7. The synthesis device of claim 3, wherein the speaker classifier neural network includes a gradient reversal layer (GRL) that is configured to remove speaker data from the first vector data.

8. The synthesis device of claim 3, wherein the synthesizing of the singing voice comprises:
encoding the MIDI feature data into second vector data by using an embedding layer and determining a probability distribution of the second vector data by learning the second vector data through a learning model;
performing normalization to transform the second vector data by using a normalizing flow to generate first vector data;
generating a Mel-spectrogram, with the trained voice decoder neural network, based on the probability distribution of the first vector data; and
synthesizing, with a vocoder, the singing voice based on the Mel-spectrogram.

9. The synthesis device of claim 8, wherein the normalizing flow is trained to match the probability distribution of the first vector data with the probability distribution of the second vector data by using a second loss function.

10. The synthesis device of claim 9, wherein the learning model includes a transformer, and
wherein the second loss function includes Kullback-Leibler (KL) divergence.

11. A synthesis method of a singing voice of a speaker, the method comprising:
obtaining raw voice data and musical instrument digital interface (MIDI) data;
extracting voice feature data based on the raw voice data;
extracting MIDI feature data from the MIDI data;
performing training of a first machine-learning network, wherein the training comprises generating modulation voice data with the first machine-learning network based on the voice feature data and adjusting parameters of the first machine-learning network based on the modulation voice data; and
synthesizing the singing voice by generating an audio waveform with the trained first machine-learning network based on the MIDI feature data.

12. The method of claim 11, wherein the voice feature data includes pitch data and spectrogram data extracted based on at least one hyperparameter, and
wherein the MIDI feature data includes height feature data from converting sound pitch, length feature data from converting a sound length, and phoneme feature data from converting text.

13. The method of claim 12, wherein the training of the first machine-learning network comprises:
encoding, by a voice encoder neural network, the spectrogram data into first vector data including time data;
decoding, by a voice decoder neural network, the first vector data and the pitch data to generate the modulation voice data; and
predicting, by a speaker classifier neural network, the speaker based on the first vector data.

14. The method of claim 13, wherein each of the voice encoder neural network and the voice decoder neural network includes at least one convolution layer.

15. The method of claim 13, wherein the training of the machine-learning network comprises:
training the voice decoder neural network to reduce an error between first spectrogram data extracted from the raw voice data and second spectrogram data generated from the modulation voice data, wherein the error is based on a first loss function.

16. The method of claim 15, wherein the first loss function includes a MAE.

17. The method of claim 13, wherein the speaker classifier neural network includes a gradient reversal layer (GRL) that is configured to remove speaker data from the first vector data.

18. The method of claim 13, wherein the synthesizing of the singing voice includes:
encoding, by a MIDI encoder neural network, the MIDI feature data into second vector data by using an embedding layer and determining a probability distribution of the second vector data by learning the second vector data through a learning model;
transforming the second vector data by using a normalizing flow to generate first vector data;
generating, by the trained voice decoder neural network, Mel-spectrogram based on the probability distribution of the first vector data; and
synthesizing, by a vocoder, the singing voice based on the Mel-spectrogram.

19. The method of claim 18, wherein the normalizing flow is trained to match the probability distribution of the first vector data with the probability distribution of the second vector data by using a second loss function.

20. The method of claim 19, wherein the learning model includes a transformer, and
wherein the second loss function includes KL divergence.
